(19) United States
(12) Patent Application Publication
(10) Pub. No.: US 2025/0306968 A1
(43) Pub. Date: Oct. 2, 2025

(54) ON-DEMAND PREDICTIVE ANALYSIS FOR DATA PROCESSING SYSTEM

(71) Applicant: Dell Products L.P., Round Rock, TX (US)

(72) Inventors: ANKIT SINGH, Bangalore (IN); SHRIKANT U. HALLUR, Bangalore (IN); NAVEEN AWASTHY, Bangalore (IN)

(21) Appl. No.: 18/618,340

(22) Filed: Mar. 27, 2024

(51) Int. Cl. G06F 9/455

(52) U.S. Cl. CPC G06F 9/45558

(57) ABSTRACT

Methods and systems for managing operation of a data processing system that hosts virtual machines that contribute to computer implemented services provided by the data processing system are disclosed. The virtual machines may collect telemetry data on the data processing system to share with a predictive model that is hosted by a container instance. The predictive model may make a prediction for a future state of the data processing system. The prediction may be shared with a management entity module that monitors operation of the data processing system. The management entity module may implement an action, based on the prediction, to manage the operation of the data processing system.

### FIELD

Embodiments disclosed herein relate generally to managing operation of a data processing system that hosts virtual machines that contribute to computer implemented services provided by the data processing system. More particularly, embodiments disclosed herein relate to implementing an action, based on telemetry data from the virtual machines, to manage the operation of the data processing system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1B show a diagram illustrating a system in accordance with an embodiment.

FIGS. 2A-2C show interaction diagrams illustrating operation of a system in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system that hosts virtual machines that contribute to computer implemented services provided by the data processing system. The operation of the data processing system may be managed by implementing an action based on a prediction by a predictive model. The prediction may be generated using telemetry data from the virtual machines.

The virtual machines may collect telemetry data from the data processing system. The telemetry data may include attributes of hardware and/or software on the data processing system (e.g., processor speed, available memory, available storage device space, computer processing unit (CPU) clock speed, CPU temperature monitor). The telemetry data may be shared with a predictive model that is hosted by a container instance. The container instance may be launched when telemetry data is ready to be shared.

The predictive model may receive and ingest the telemetry data. After ingesting the telemetry data, the predictive model may make the prediction on a future state of the data processing system. The prediction may be shared with a management entity module. The management entity module may be software that monitors operation of the data processing system and implements an action, based on the prediction, on the data processing system.

After the action is implemented by the management entity module, the data processing system may deallocate computing resources from the container instance. By the deallocation of the computing resources, the container instance may be disabled. The container instance may be disabled to limit consumption of computing resources by the predictive model in the container instance.

In an embodiment, a method for managing operation of a data processing system that hosts virtual machines that contribute to computer implemented services provided by the data processing system is disclosed. The method may include (i) obtaining, by the data processing system, telemetry data from the virtual machines; (ii) identifying, by the data processing system and the telemetry data, a forecasting process of multiple forecasting processes that may be performed to predict a future state of the data processing system; (iii) obtaining, by the data processing system and from a remote entity, a container image based on the forecasting process; (iv) obtaining, by the data processing system and using the container image, a container instance hosted by the data processing system; (v) obtaining, by the data processing system and using the container instance and the telemetry data, a prediction for a future operating state of the data processing system; (vi) updating, by the data processing system, operation of the data processing system based on the prediction for the future operating state to obtain an updated data processing system; and (vii) providing, by the updated data processing system, the computer implemented services.

Identifying the forecasting process of the multiple forecasting processes may include (i) obtaining at least one piece of information from a list of pieces of information consisting of: (a) an enumeration of the telemetry data, (b) a desired type of the future state prediction for the data processing system, and (c) available computing resources of the data processing system; and (ii) selecting, based on the at least one piece of information, the forecasting process to predict the future state of the data processing system.

The forecasting process may use a predictive model that ingests the telemetry data and uses the available computing resources to predict the future state of the data processing system.

The multiple forecasting processes may use predictive models that ingest different input data, operate using different amounts of the available computing resources, and generate different types of the future state predictions.

The future state may include at least one state selected from a group of states consisting of a future health state, a future security state, and a future resource availability state.

The remote entity may be a cloud system that hosts the container images.

Updating operation of the data processing system may include reducing used computing resources of the data processing system and by the container instance when at least condition is met from a set of conditions consisting of: (i) selection of an action to update the operation of the data processing system is selected; (ii) performance of the action to update the operation of the data processing system; (iii) operation of the container instance enters an idle state after generating the prediction; and (iv) available computing resources of the data processing system fall below a threshold amount.

Reducing the use of the computing resource may include (i) terminating operation of the container instance; and (ii) deallocating computing resource committed to the container instance.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

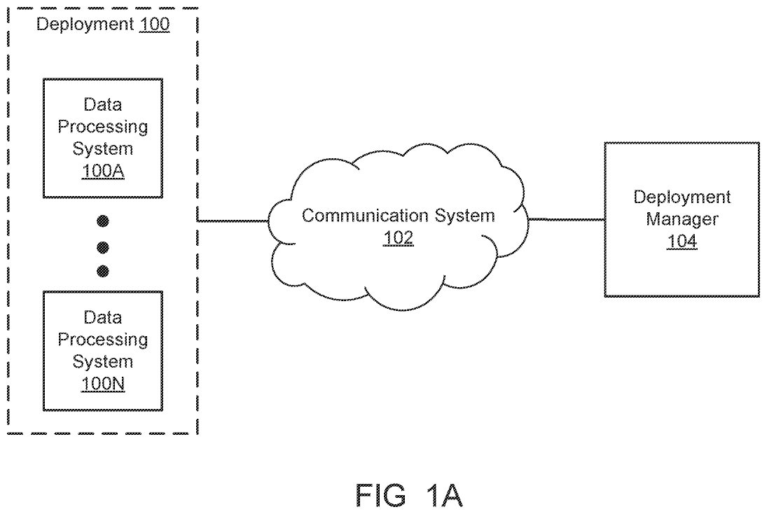

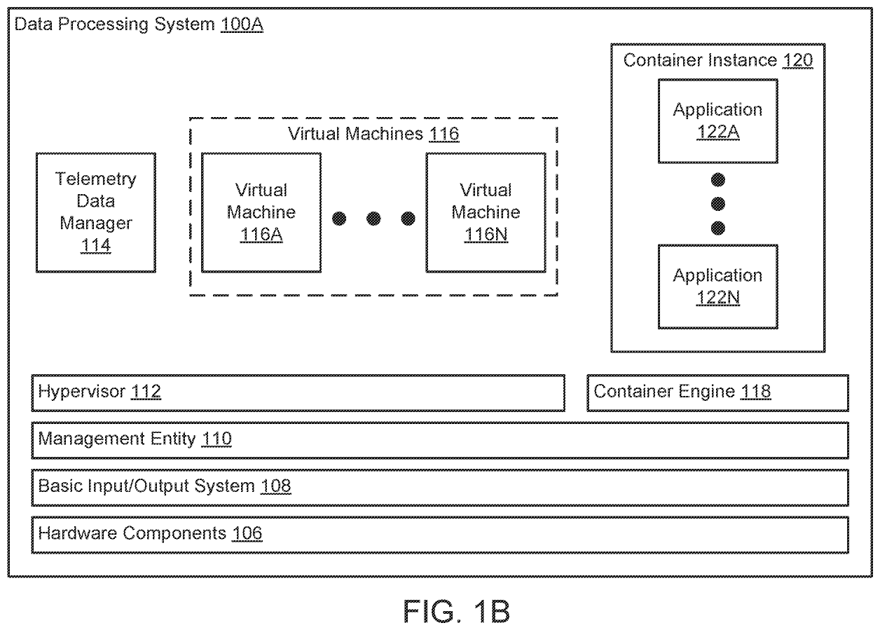

Turning to FIG. 1A, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, the data processing system may implement a predictive model. The predictive model may monitor hardware and/or software, automate tasks, and/or make predictions on a future state of the data processing system.

The predictive model may make predictions by ingesting telemetry data from the data processing system and processing the telemetry data to predict a future state of the hardware and/or the software. The telemetry data may include attributes of the hardware and/or the software (e.g., processor speed, available memory, available storage device space, computer processing unit (CPU) clock speed, CPU temperature monitor).

However, execution of the predictive model may consume an undesirable quantity of computing resources that may otherwise be allocated for provision of computer implemented services. For example, disk space on the storage device space may be allotted for the ingestion and the processing of the telemetry data. Also, the CPU cycles may be allocated to ingest and process the telemetry data, as opposed to providing computer implemented services desired by user of the data processing systems.

Therefore, the ingesting and the processing of the telemetry data may limit availability of computing resources for the provision of the computer implemented services. Consequently, an availability and/or quality of the computer implemented services may be negatively impacted.

However, the predictions provided by the predictive model may be necessary for effective management of operation of the data processing systems. For example, the predictions provided by the predictive model may be used to make various management decisions. Without access to the predictions, the operation of the data processing systems may suffer (e.g., the data processing system may schedule too many operations to be performed during various periods of time, thereby contributing to poor performance as perceived by users of the data processing systems).

In general, embodiments disclosed here relate to systems and methods for managing operation of data processing systems. The operation of the data processing systems may be managed by limiting expenditure of computing resources for operation of predictive models that do not directly contribute to computer implemented services. The computing resource expenditures may be limited by (i) dynamically instantiating and terminating containers that host predictive models, and (ii) selecting and using types of predictive models based on requirements for predictions.

During operation, the containers may ingest telemetry data and providing corresponding predictions. The predictions may be used for any number of purposes.

To obtain the telemetry data, the operation of the data processing systems may be monitored. For example, the data processing systems may host virtual machines that consume computing resources and provide computer implemented services. The virtual machines may be individually monitored to obtain information regarding the hardware and/or the software on the data processing system (e.g., processor speed, available memory, available storage device space, computer processing unit (CPU) clock speed, CPU temperature monitor). By obtaining the information regarding the hardware and/or the software on the data processing system, a present state of the data processing systems may be identified.

Using the present states of the data processing systems, operation of the data processing system may be managed. The operation of the data processing system may be managed by determining a future state of the data processing system. The future state may be determined by predicting the future state of the data processing system using a predictive model. The future state of the data processing system may be predicted by ingesting the telemetry data from the virtual machines (e.g., representing the current state) and processing the ingested telemetry data by the predictive model. The predictive model may output the future state (e.g., future resource consumption, operability of various hardware/software components, etc.).

However, execution of the predictive model may consume an undesirable quantity of computing resources. The consumption of computing resources by the predictive model may limit an availability and/or quality of computer implemented services by the data processing system. To limit the consumption by the predictive model, the predictive model may be packaged in a container. An instance of the container instance may run only when predictions are needed.

Once a prediction of the future state of the data processing system is generated, the container instance may be disabled (e.g., terminated, suspended, etc.). After (or as part of) disabling the container instance, computing resources may be deallocated from the container instance and made available to the data processing system. Through use of the container instance to execute the predictive model, allocation of the computing resources for making the prediction of the future state of the data processing system may be reduced. Limiting execution of the predictive model to when telemetry data is available may improve an availability and/or quality of computer implemented services by the data processing system by improving the resources available for providing other, desired computer implemented services.

To provide the above noted functionality, the system may include deployment 100 and deployment manager 104. Each of these components is discussed below.

Deployment 100 may include any number of data processing systems 100A-100N. Data processing systems 100A-100N may provide the desired computer implemented services. To provide the desired computer implemented services, data processing systems 100A-100N may obtain and use predictive models from deployment manager 104. The predictive models may be packaged as containers, and may be selected based, at least, on the types of predictions that are required. The predictions may be used, for example, to update operation of the data processing systems. Doing so may improve, indirectly, the computer implemented services provided by the data processing systems. Refer to FIG. 1B for additional information regarding data processing systems 100A-100N.

Deployment manager 104 may manage the operation of data processing systems 100A-100N. To manage the operation of the data processing systems, deployment manager 104 may provide access to containerized predictive models. Deployment manager 104 may host a variety of different containerized predictive models which may have different characteristics, capabilities, etc. The predictive model may be, for example, trained inference models (e.g., neural networks, regression models, etc.) based on historic operation data of the data processing systems.

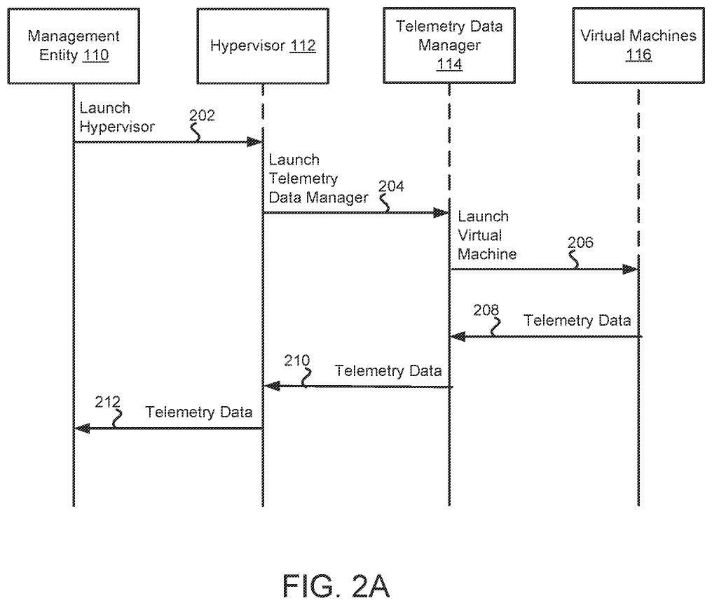

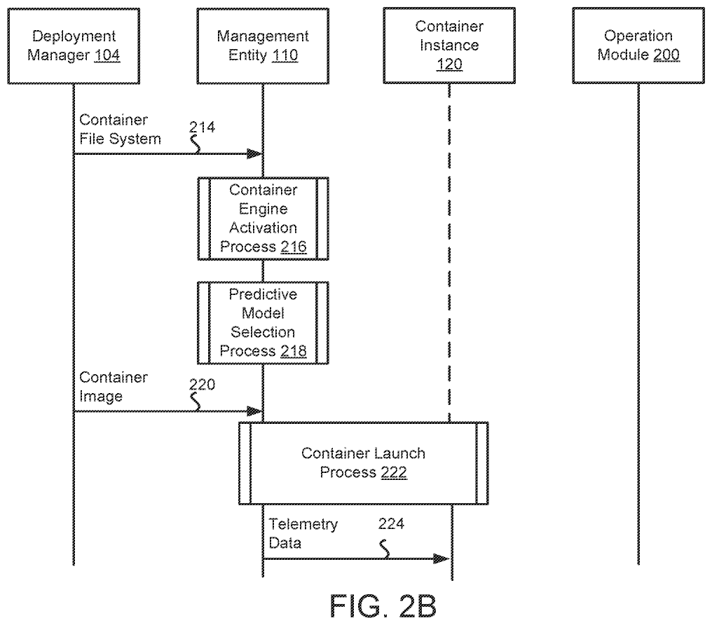

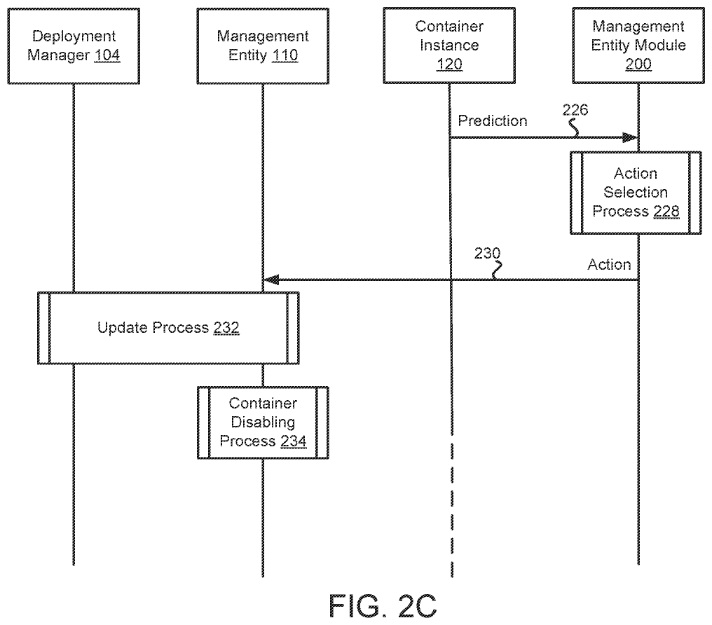

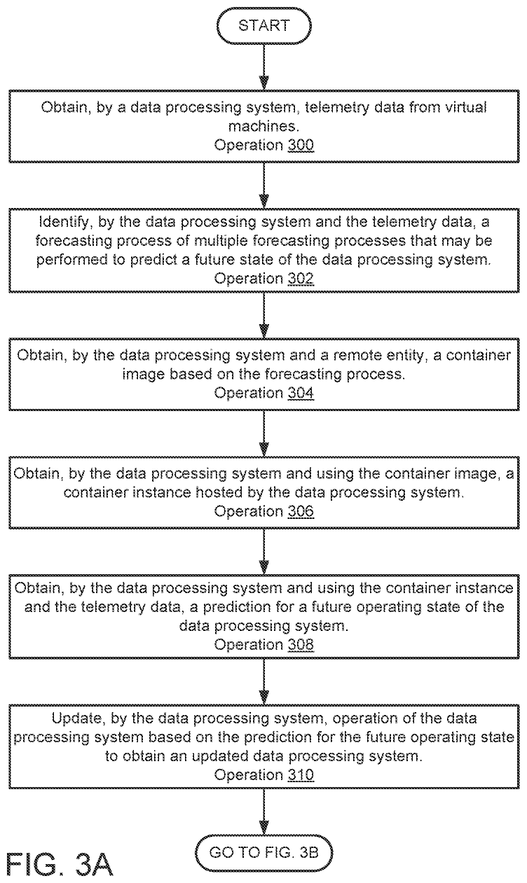

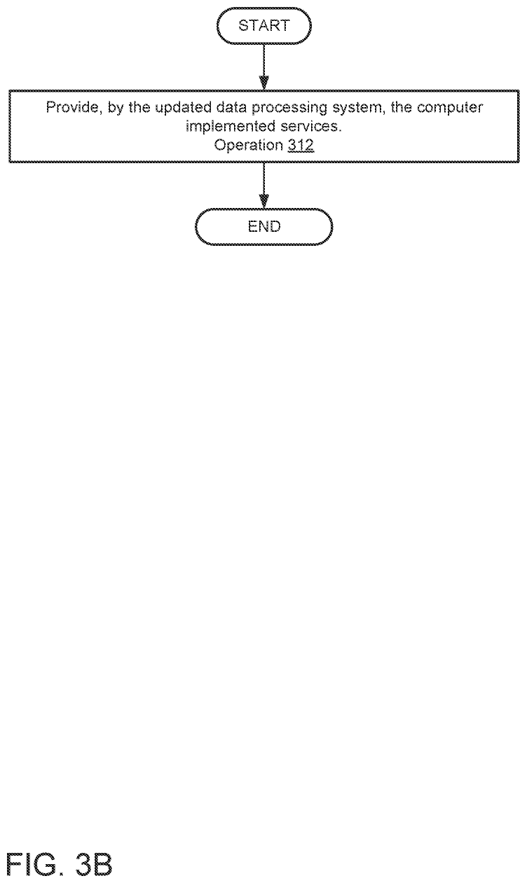

While providing their functionality, any of deployment 100 and deployment manager 104 may perform all, or a portion, of the flows and methods shown in FIGS. 2A-3B.

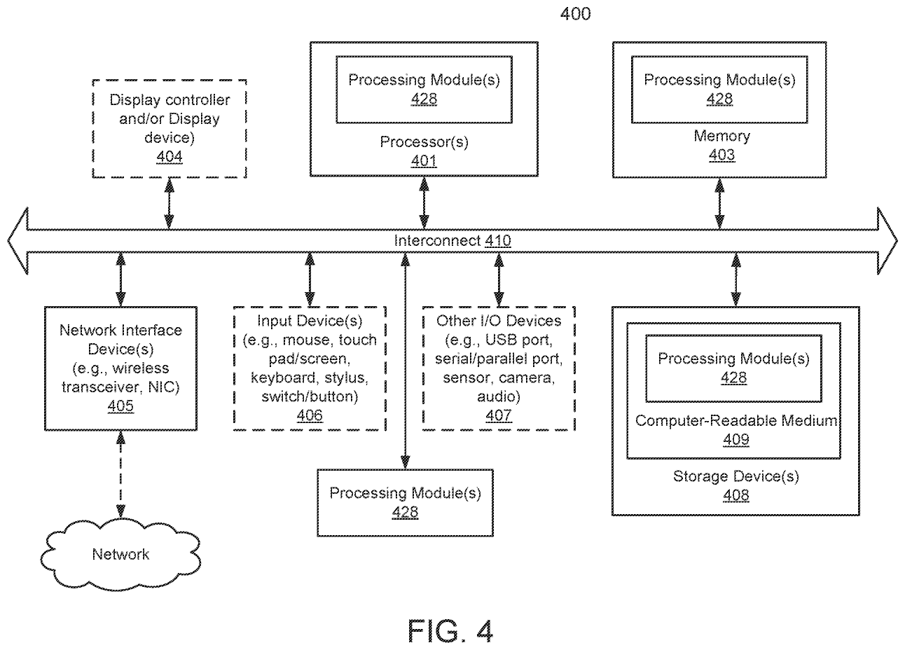

Any of (and/or components thereof) deployment 100 and deployment manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

While illustrated with a limited number of specific components, a system in accordance with an embodiment may include additional, fewer, and/or different components from those illustrated in FIG. 1A.

Turning to FIG. 1B, a diagram illustrating data processing system 100A in accordance with an embodiment is shown.

To provide computer implemented services, data processing system 100A may include any quantity of hardware components 106. Hardware components 106 may include physical parts of data processing system 100A that store and run software. Hardware components 106 may include a motherboard, CPU, disk storage device, memory, etc. On the motherboard and/or read-only memory, basic input/output system 108 may be stored.

Basic input/output system 108 may be used to startup data processing system 100A. On the startup, basic input/output system 108 may configure peripheral devices, such as a keyboard, mouse, monitor, etc. With the peripheral devices, basic input/output system 108 may configure hardware components 106 for use by data processing system 100A. After basic input/output system 108 has configured the peripheral devices and hardware components 106 for use by data processing system 100A, management entity 110 may be activated.

Management entity 110 may be software similar to an operating system. Management entity 110 may interface between hardware and/or software in data processing system 100A. Through interfacing, management entity 110 may permit the software to access computing resources from the hardware.

Hypervisor 112 may provide access to computing resources provided by hardware components 106. For example, hypervisor 112 may provide time sliced access to the computing resources. Hypervisor 112 may provide the time sliced access to virtual machines 116.

Virtual machines 116 may include any number of virtual machine 116A-116N. Virtual machines 116A-116N may host an operating system and one or more applications that provide desired computer implemented services. Additionally, virtual machines may host an agent that may cooperate with telemetry data manager 114 (e.g., another virtual machine) to provide for granular telemetry data collection at the virtual machine level.

To facilitate use of containerized predictive models, data processing system 100A may also include container engine 118. Container engine may be an engine usable to provide container instances (e.g., 120) with access to computing resources. For example, container instance 120 may host applications 122A-122N. Applications 122A-122N may be predictive models and/or other types of applications.

To manage operation of data processing system 100A, telemetry data manager 114 may facilitate collection of telemetry data. To facilitate transmission of the telemetry data, virtual machine 116A-116N may first collect the telemetry data regarding a present state of the data processing system (e.g., resource usage, hosted application, configurations of application, security settings, etc.). The telemetry data may be passed from virtual machine 116A-116N by telemetry data manager 114 through hypervisor 112 to management entity 110. Management entity 110 may pass the telemetry data to container instance 120 (e.g., via container engine 118 or other paths). The applications (e.g., 122A-122N) hosted by container instance may use the telemetry data to predict a future state of data processing system 100A.

Container instance 120 and container engine 118 may only be present while predictions are desired. If a prediction is desired, then either may be instantiated so that computing resources are only consumed while predictions are being generated.

Over time, container instances hosting various applications (e.g., different predictive models) may be instantiated depending on the type of desired/necessary prediction.

Thus, using the architecture illustrated in FIG. 1B, a system in accordance with an embodiment may limit resource consumption while providing for prediction generation.

To further clarify embodiments disclosed herein, interactions diagrams in accordance with an embodiment are shown in FIGS. 2A-2C. These interactions diagrams may illustrate how data may be obtained and used within the system of FIG. 1A-1B.

In the interaction diagrams, processes performed by and interactions between components of a system in accordance with an embodiment are shown. In the diagrams, components of the system are illustrated using a first set of shapes (e.g., 110, 112, etc.), located towards the top of each figure. Lines descend from these shapes. Processes performed by the components of the system are illustrated using a second set of shapes (e.g., 216, 218, etc.) superimposed over these lines. Interactions (e.g., communication, data transmissions, etc.) between the components of the system are illustrated using a third set of shapes (e.g., 202, 204, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 202 may occur prior to the interaction labeled as 204. However, it will be appreciated that the processes and interactions may be performed in different orders, any may be omitted, and other processes or interactions may be performed without departing from embodiments disclosed herein.

The lines descending from some of the first set of shapes (e.g., 120, etc.) is drawn in dashing to indicate, for example, that the corresponding components may not be (i) operable, (ii) powered on, (iii) present in the system, and/or (iv) not participating in operation of the system for other reasons.

Turning to FIG. 2A, a first interaction diagram in accordance with an embodiment is shown. The first interaction diagram may illustrate processes and interactions that may occur during transfer of telemetry data to management entity 110. The telemetry data may be transferred to management entity 110 where management entity 110 may further pass the telemetry data to a container instance.

At interaction 202, a launch hypervisor command may be provided to hypervisor 112 by management entity 110. For example, the launch hypervisor command may be generated and provided to hypervisor 112 via (i) transmission via a message, (ii) storing in a storage with subsequent retrieval by hypervisor 112, (iii) via a publish-subscribe system where hypervisor 112 subscribes to updates from management entity 110 thereby causing a copy of the launch hypervisor command to be propagated to hypervisor 112, and/or via other processes. By providing the launch hypervisor command to hypervisor 112, hypervisor 112 may be launched. Hypervisor 112 may be launched to oversee operation of any number of virtual machines run by the data processing system.

Once hypervisor 112 has been launched, at interaction 204, a launch telemetry data manager command may be provided to telemetry data manager 114 by hypervisor 112. For example, the launch telemetry data manager command may be generated and provided to telemetry data manager 114 via (i) transmission via a message, (ii) storing in a storage with subsequent retrieval by telemetry data manager 114, (iii) via a publish-subscribe system where telemetry data manager 114 subscribes to updates from hypervisor 112 thereby causing a copy of the launch telemetry data manager command to be propagated to telemetry data manager 114, and/or via other processes. By providing the launch telemetry data manager command to telemetry data manager 114, telemetry data manager 114 may be launched. Telemetry data manager 114 may be launched to collect the telemetry data from any number of the virtual machines hosted by the data processing system.

To generate the telemetry data, at interaction 206, a launch virtual machine command may be provided to inactive instances of virtual machines 116 by management entity 110. For example, the launch virtual machine command may be generated and provided to virtual machines 116 via (i) transmission via a message, (ii) storing in a storage with subsequent retrieval by virtual machines 116, (iii) via a publish-subscribe system where virtual machines 116 subscribes to updates from management entity 110 thereby causing a copy of the launch virtual machine command to be propagated to virtual machines 116, and/or via other processes. By providing the launch hypervisor command to virtual machines 116, virtual machines 116 may be launched. Virtual machines 116 may be launched to provide desired computer implemented services, and facilitate collection of telemetry data from the data processing system while the computer implemented services are provided.

To send the telemetry data to management entity 110, at interaction 208, the telemetry data may be sent by virtual machines 116 to telemetry data manager 114. The telemetry data may be sent by an inter-process communication method, such as, for example, shared memory, sockets, pipes, message queues, etc. Once the telemetry data has been received by telemetry data manager 114, the telemetry data may be sent by telemetry data manager 114 to hypervisor 112. The telemetry data may include attributes of hardware and/or software on the data processing system (e.g., processor speed, available memory, available storage device space, computer processing unit (CPU) clock speed, CPU temperature monitor).

To send the telemetry data to hypervisor 112, at interaction 210, the telemetry data may be sent by telemetry data manager 114 to hypervisor 112. The telemetry data may be sent by the inter-process communication method, such as, for example, shared memory, sockets, pipes, message queues, etc. Once the telemetry data has been received by hypervisor 112, the telemetry data may be sent by hypervisor 112 to management entity 112.

To send the telemetry data to management entity 110, at interaction 212, the telemetry data may be sent by hypervisor 112 to management entity 110. The telemetry data may be sent by the inter-process communication method, such as, for example, shared memory, sockets, pipes, message queues, etc.

The telemetry data from any number of virtual machines may be aggregated by management entity 110 in this manner. Once aggregated, management entity 110 may transfer the telemetry data to any number of components within the data processing system. Management entity 110 may transfer the telemetry data to any number of the components because management entity 110 may include software that operates at a kernel level for the data processing system. Software that operates at a kernel level for the data processing system may run commands and/or transfer data to any component of the data processing system.

For example, the aggregated telemetry data may be provided to a container instance in which a predictive model is present, and able to predict the future state of the data processing system using the aggregated telemetry data.

Turning to FIG. 2B, a second interaction diagram in accordance with an embodiment is shown. The second interaction diagram may illustrate processes and interactions that may occur during transfer of telemetry data to container instance 120. The telemetry data may be transferred to container instance 120 to be ingested by a prediction model hosted by container instance 120.

To transfer the telemetry data, at interaction 214, a container file system may be transferred from deployment manager 104 to management entity 110. The container file system may be transferred by sending the container file system from deployment manager 104 to management entity 110 and mounting the container file system on management entity 110. Once the container file system is mounted, files and directories on the container file system may be accessible using management entity 110. After mounting the container file system, container engine activation process 216 may be performed.

During container engine activation process 216, a container engine may be enabled to host any number of instances of containers based on container images. The container engine may enable hosting of a container images by sharing the container file system with the container image. When the container file system is shared with the container image, a container instance may be launched. The container instance may run any number of applications with libraries, binaries, and/or dependencies on the container file system. To launch the container instance that is desired (e.g., from multiple available type of container instances having different types of predictive models), predictive model selection process 218 may be performed.

During predictive model selection process 218, a container image with a predictive model may be selected. The container image may be selected based on (i) a type of predictive model, (ii) a type of the telemetry data collected from virtual machines 116 to be input into the predictive model, and/or (iii) computing resources that are available to run the predictive model. The types of the predictive model may include supervised, semi-supervised, unsupervised, reinforcement learning, etc. The types of the telemetry data that may be input into the predictive model may include numerical data, categorical data, time series data, text data, and/or other types of data. The availability of the computing resources on the data processing system may limit how much disk storage and/or memory may be allocated for use by the container image. The container image may be selected based on these and/or other factors.

Once the type of predictive model is selected, then the corresponding container image may be transferred.

To transfer the container image, at interaction 220, the container image with the predictive model may be transferred (e.g., via any method) from deployment manager 104 to management entity 110. The container image may be stored in memory and/or on a disk storage device. If the container image is stored on memory, retention of the container image by management entity 110 may be impacted after management entity 110 is powered down. As management entity 110 is powered down, the container image may be removed from memory. Otherwise, if the container image is stored on the disk storage drive, the container image may be reliably stored in the disk storage drive. Once the container image is transferred to management entity 110, container launch process 222 may be performed (e.g., presuming there is an immediate need for predicting a future state of the how system).

During container launch process 222, the container image may be used to launch container instance 120. Container instance 120 may be an instance of the container image. Container instance 112 may be launched by running the container image on any number of processors of management entity 110. As container instance 112 runs, any number of applications 122A-122N and libraries, binaries, and dependencies used by applications 122A-122N within the container image may be launched. As application 122A-122N runs, telemetry data may be transferred to container instance 120.

To transfer the telemetry data to container instance 120, at interaction 224, the telemetry data collected by virtual machines 116 may be stored by management entity 110. The telemetry data may be stored in memory in the container file system in management entity 110. The telemetry data may be transferred using an inter-process communication method, such as, for example, shared memory, sockets, pipes, message queues, etc.

Once the telemetry data is obtained, container instance 120 may transfer the telemetry data to application 122A-122N, which may include the predictive model. Thus, the predictive model may be in condition to generate predictions of the future operation of the host system.

Turning to FIG. 2C, a third interaction diagram in accordance with an embodiment is shown. The third interaction diagram may illustrate processes and interactions that may occur during use of predictions and disabling of container instance 120 after the predictions are generated.

For example, at interaction 226, a prediction from the predictive model may be sent from container instance 120 to management entity module 200. The prediction may include a future state of the data processing system. The future state of the data processing system may include a set of future values for processor speed, available memory, available storage device space, CPU clock speed, CPU temperature monitor, security statuses, health statuses, and/or other types of information regarding the future state of the data processing system.

The prediction may be received by management entity module 200. Management entity module 200 may be software that operates alongside management entity 110 at the kernel level of the data processing system. The software may monitor operations of any number of pieces of software in the data processing system. Also, the software may implement actions selected by management entity 200 based on the monitoring of the operations.

Once the set of the future state of the data processing system is received by management entity module 200, action selection process 228 may be performed. During action selection process 228, an action may be selected by management entity module 200 based on the future state of the data processing system. Selection of the action may be based upon improving performance of the hardware and/or software of the data processing system. Following selection of the action, the action may be sent, at interaction 230, to management entity 110 for implementation on the data processing system. The actions may include (i) clearing memory and/or disk storage space to improve a storage capacity; (ii) lowering the CPU clock speed to control temperatures of hardware; (iii) reallocating data processing on multiple processors, and/or other processes. Management entity 110 may perform the actions received from management entity module 200, thereby updating the operating state of the how system.

Once the action has been performed, update process 232 may be performed. During update process 232, the prediction model in application 122A-122N may be updated. The prediction model may be updated by checking for updates for the prediction model and transferring the updates to container instance 120. The updates may be checked by sending a message by a cloud system to deployment manager 104 to request the updates. The message may be received by deployment manager 104 and a response may be sent from deployment manager 104. The response may include the updates. The updates may be applied to the predictive model in application 122A-122N to update the predictive model. The updates may be applied after the action has been performed so that new container instances include predictive models that operate efficiently and maintain current standards. Once the predictive model is updated, then container disabling process 234 may be performed.

During container disabling process 234, container instance 120 may be disabled. Container instance 120 may be disabled because there is no need for additional predictions to be generated. To disable container instance 120, management entity 120 may deallocate computing resources from container instance 120. Once the computing resources have been deallocated from container instance 120, container instance 120 may be disabled.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1A may perform various methods to manage the operation of data processing systems using predictions. FIGS. 3A-3B illustrate methods that may be performed by the components of the system of FIG. 1A-1B. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of managing operation of a data processing system that hosts virtual machines that contribute to computer implemented services provided by the data processing system in accordance with an embodiment is shown. The method may be performed, for example, by any of the components of the system of FIG. 1A-1B, and/or other components not shown therein.

At operation 300, telemetry data may be obtained by the data processing system from the virtual machines. The telemetry data may be obtained by receiving the telemetry data from the virtual machines through an interprocess communication method, including shared memory, sockets, pipes, message queues, etc.

At operation 302, a forecasting process of multiple forecasting processes may be identified, by the data processing system and the telemetry data, that may be performed to predict a future state of the data processing system. The forecasting process of the multiple forecasting processes may be identified by obtaining at least one piece of information from a list of pieces of information consisting of (i) an enumeration of the telemetry data, (ii) a desired type of the future state prediction for the data processing system, and/or (iii) available computing resources of the data processing system; and selecting, based on the at least one piece of information, the forecasting process to predict the future state of the data processing system.

The at least one piece of information from the list of pieces of information may be obtained by (i) identifying a type and/or quality of the telemetry data; (ii) identifying attributes of the desired type of future state predictions for the data processing system; and (iii) identifying the available computing resources of the data processing system. The forecasting process may be selected by identifying the forecasting process that (i) ingests the telemetry data; (ii) outputs the desired type of the future state prediction; and/or (iii) uses the available computing resources of the data processing system.

At operation 304, a container image based on the forecasting process may be obtained by the data processing system and from a remote entity. The container image may be obtained by the data processing system by receiving the container image from the remote entity.

At operation 306, a container instance, hosted by the data processing system, may be obtained by the data processing system and using the container image. The container instance may be obtained by executing the container image with a container engine in the data processing system.

At operation 308, a prediction for a future operating state of the data processing system may be obtained by the data processing system and using the container instance and the telemetry data. The prediction may be obtained by (i) ingesting, by the container instance, the telemetry data; (ii) processing, by the container instance, the telemetry data to generate the prediction; and (iii) receiving, from the container instance and by the data processing system, the prediction.

At operation 310, operation of the data processing system, based on the prediction for the future operating state to obtain an updated data processing system, may be updated by the data processing system. The operation of the data processing system may be updated by reducing use computing resources of the data processing system and by the container instance when at least condition is met from a set of conditions consisting of: (i) selection of an action to update the operation of the data processing system is selected; (ii) performance of the action to update the operation of the data processing system; (iii) operation of the container instance enters an idle state after generating the prediction; and (iv) available computing resources of the data processing system fall below a threshold amount.

The use of the computing resources may be reduced (i) by terminating operation of the container instance; and (ii) deallocating computing resources committed to the container instance. The operation of the container instance may be terminated by sending a message to the container engine to deallocate computing resources committed to the container instance. The message may be sent through the interprocess communication method, including shared memory, sockets, pipes, message queues, etc. The computing resources committed to the container instance may be deallocated by releasing memory from an allocation of the container instance.

Turning to FIG. 3B, a flow diagram illustrating a continuation of the flow diagram shown in FIG. 2A in accordance with an embodiment is shown.

At operation 312, computer implemented services may be provided by the updated data processing system. The computer implemented services may be provided by performing operations using the update data processing system.

The method may end following operation 312.

Any of the components illustrated in FIGS. 1A-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system that hosts virtual machines that contribute to computer implemented services provided by the data processing system, the method comprising:
obtaining, by the data processing system, telemetry data from the virtual machines;
identifying, by the data processing system and the telemetry data, a forecasting process of multiple forecasting processes that may be performed to predict a future state of the data processing system;
obtaining, by the data processing system and from a remote entity, a container image based on the forecasting process;
obtaining, by the data processing system and using the container image, a container instance hosted by the data processing system;
obtaining, by the data processing system and using the container instance and the telemetry data, a prediction for a future operating state of the data processing system;
updating, by the data processing system, operation of the data processing system based on the prediction for the future operating state to obtain an updated data processing system; and
providing, by the updated data processing system, the computer implemented services.

2. The method of claim 1, wherein identifying the forecasting process of the multiple forecasting processes comprises:
obtaining at least one piece of information from a list of pieces of information consisting of:
an enumeration of the telemetry data,
a desired type of the future state prediction for the data processing system, and
available computing resources of the data processing system; and
selecting, based on the at least one piece of information, the forecasting process to predict the future state of the data processing system.

3. The method of claim 2, wherein the forecasting process uses a predictive model that ingests the telemetry data and uses the available computing resources to predict the future state of the data processing system.

4. The method of claim 3, wherein the multiple forecasting processes use predictive models that ingest different input data, operate using different amounts of the available computing resources, and generate different types of the future state predictions.

5. The method of claim 1, wherein the future state comprises at least one state selected from a group of states consisting of a future health state, a future security state, and a future resource availability state.

6. The method of claim 1, wherein the remote entity is a cloud system that hosts the container images.

7. The method of claim 1, wherein updating operation of the data processing system comprises:
reducing used computing resources of the data processing system and by the container instance when at least condition is met from a set of conditions consisting of:
selection of an action to update the operation of the data processing system is selected;
performance of the action to update the operation of the data processing system;
operation of the container instance enters an idle state after generating the prediction; and
available computing resources of the data processing system fall below a threshold amount.

8. The method of claim 7, wherein reducing the use of the computing resource comprises:
terminating operation of the container instance; and
deallocating computing resource committed to the container instance.

9. A non-transitory machine-readable medium having instructions stored therein, which when executed by a processor, cause the processor to perform operations for managing operation of a data processing system that hosts virtual machines that contribute to computer implemented services provided by the data processing system, the operation comprising:
obtaining, by the data processing system, telemetry data from the virtual machines;
identifying, by the data processing system and the telemetry data, a forecasting process of multiple forecasting processes that may be performed to predict a future state of the data processing system;
obtaining, by the data processing system and from a remote entity, a container image based on the forecasting process;
obtaining, by the data processing system and using the container image, a container instance hosted by the data processing system;
obtaining, by the data processing system and using the container instance and the telemetry data, a prediction for a future operating state of the data processing system;
updating, by the data processing system, operation of the data processing system based on the prediction for the future operating state to obtain an updated data processing system; and
providing, by the updated data processing system, the computer implemented services.

10. The non-transitory machine-readable medium of claim 9, wherein identifying the forecasting process of the multiple forecasting processes comprises:
obtaining at least one piece of information from a list of pieces of information consisting of:
an enumeration of the telemetry data,
a desired type of the future state prediction for the data processing system, and
available computing resources of the data processing system; and
selecting, based on the at least one piece of information, the forecasting process to predict the future state of the data processing system.

11. The non-transitory machine-readable medium of claim 10, wherein the forecasting process uses a predictive model that ingests the telemetry data and uses the available computing resources to predict the future state of the data processing system.

12. The non-transitory machine-readable medium of claim 11, wherein the multiple forecasting processes use predictive models that ingest different input data, operate using different amounts of the available computing resources, and generate different types of the future state predictions.

13. The non-transitory machine-readable medium of claim 9, wherein the future state comprises at least one state selected from a group of states consisting of a future health state, a future security state, and a future resource availability state.

14. The non-transitory machine-readable medium of claim 9, wherein the remote entity is a cloud system that hosts the container images.

15. A data processing system, comprising:
a processor; and
a memory coupled to the processor to store instructions, which when executed by the processor, cause the processor to perform operations managing operation of a data processing system that hosts virtual machines that contribute to computer implemented services provided by the data processing system, the operations comprising:
obtaining, by the data processing system, telemetry data from the virtual machines;
identifying, by the data processing system and the telemetry data, a forecasting process of multiple forecasting processes that may be performed to predict a future state of the data processing system;
obtaining, by the data processing system and from a remote entity, a container image based on the forecasting process;
obtaining, by the data processing system and using the container image, a container instance hosted by the data processing system;
obtaining, by the data processing system and using the container instance and the telemetry data, a prediction for a future operating state of the data processing system;
updating, by the data processing system, operation of the data processing system based on the prediction for the future operating state to obtain an updated data processing system; and
providing, by the updated data processing system, the computer implemented services.

16. The data processing system of claim 15, wherein identifying the forecasting process of the multiple forecasting processes comprises:
obtaining at least one piece of information from a list of pieces of information consisting of:
an enumeration of the telemetry data,
a desired type of the future state prediction for the data processing system, and
available computing resources of the data processing system; and
selecting, based on the at least one piece of information, the forecasting process to predict the future state of the data processing system.

17. The data processing system of claim 16, wherein the forecasting process uses a predictive model that ingests the telemetry data and uses the available computing resources to predict the future state of the data processing system.

18. The data processing system of claim 17, wherein the multiple forecasting processes use predictive models that ingest different input data, operate using different amounts of the available computing resources, and generate different types of the future state predictions.

19. The data processing system of claim 15, wherein the future state comprises at least one state selected from a group of states consisting of a future health state, a future security state, and a future resource availability state.

20. The data processing system of claim 15, wherein the remote entity is a cloud system that hosts the container images.
